(19) United States
(12) Patent Application Publication
(10) Pub. No.: US 2022/0097238 A1
(43) Pub. Date: Mar. 31, 2022

(54) CONFIGURING A VISUALIZATION DEVICE FOR A MACHINE ZONE

(71) Applicant: SICK AG, Waldkirch (DE)

(72) Inventors: Christopher MARTEL, Waldkirch (DE); Silja REICHERT, Waldkirch (DE); Peter POKRANDT, Waldkirch (DE); Marcus NEUMAIER, Waldkirch (DE)

(21) Appl. No.: 17/483,782

(22) Filed: Sep. 23, 2021

(30) Foreign Application Priority Data
Sep. 25, 2020 (EP) 20198357.4

(51) Int. Cl. B25J 9/16; G05B 19/12

(52) U.S. Cl. CPC B25J 9/1697; G05B 19/124; B25J 9/1676

(57) ABSTRACT

A method of configuring a visualization device for a machine zone is provided in which at least one sensor is arranged, wherein a reference marker is attached in the machine zone and an object marker is attached to the sensor, a respective at least two markers are detected by a detection device, and the two markers are linked to one another abstractly in their proximity relationship and/or geometrically in their mutual spatial locations.

The invention relates to a method of configuring a visualization device for a machine zone in which at least one sensor is arranged and to a template having an object marker for the method.

A plurality of sensors are used in a machine zone, for example a robot cell, to avoid accidents and to monitor and support the work procedures. It is exceedingly helpful in the setting up and servicing of the robot cell and the sensors to obtain information on the sensors that is not directly recognizable with the naked eye. It is known in principle to visualize such information on a mobile end device such as a smartphone. A superposition of a camera image with the additional information (augmented reality) is particularly descriptive.

The requirement for a correct display of the sensor information is a knowledge of the exact position of the sensor with respect to the camera of the mobile end device. There are approaches in the prior art to recognize and localize physical objects on which information is to be superposed using a 3D model. Not only 3D models of the physical objects are required for this purpose; the comparison between 3D models is additionally complex and prone to error, above all when the object is partly hidden, as is frequently the case.

Another possibility comprises attaching a respective marker to the object. Such a marker must be prepared individually for every object and has to be replaced together with the object or prepared again in the event of a defect. Accessibility during the attachment of the marker is already not always ensured with sensors that are installed in the system and that, for example, have an additional protective housing. The marker then also has to be readable for the visualization and for this purpose has to be recognizable completely and at a sufficient size from the location of the mobile end device despite aging phenomena such as fading or damage. Finally, the correct localization on the basis of such an optical marker represents a challenge that has not yet been satisfactorily mastered.

It is therefore the object of the invention to improve the visualization of a machine zone.

This object is satisfied by a method of configuring a visualization device in accordance with the respective independent claim. The visualization device is preferably a mobile end device such as a tablet, a smartphone, or VR glasses. Information on sensors in a machine zone should be presented by them in operation after a completed configuration. The machine zone is initially thought of as a robot cell or an integrated network on an automated guided vehicle (AGV) or an automated guided container (AGC), but the term can also be understood more broadly and designates a zone in which dynamics by a machine are to be expected at least at times, that is, for example, also a conveyor belt or a grade crossing. There is consequently at least one sensor in the machine zone that, for example, secures a machine and in the event of a risk of an accident provides for its switching into a safe state in good time or supports the machine in its work, for instance monitors work procedures or recognizes workpieces or tools or checks work results. Optoelectronic sensors are particularly suitable for such work. The method in accordance with the invention is equally suitable for visualizing information on different objects than sensors.

The invention starts from the basic idea of localizing the at least one sensor and possibly further objects on which information is to be visualized while using markers that are recorded, detected, or scanned by a detection device. The detection device is preferably likewise a mobile end device corresponding to the visualization device and can thus be identical, but does not have to be. In accordance with the invention reference markers, on the one hand, and object markers, on the other hand, are provided that are attached in the machine zone or to the sensor and are then detected and put into relationship with one another.

Reference markers are attached in a fixed position with respect to the reference system of the visualization device, for instance on the hall floor or on the frame of a vehicle, and their positions thereby become a reference location. There is initially no restriction as to what can be a reference locations; the fitter decides this by attaching the reference marker. The fitter admittedly manages with fewer reference markers that are easily visible from the key points for the configuration of the machine zone by a skillful choice, but this is not essential to the invention.

Object markers are in contrast attached to the sensor or to each of the sensors if there are a plurality of sensors. They are not called sensor markers because there can still be further objects, for instance controllers or machine parts on which information is also to be visualized and which can be integrated in the visualization by means of object markers in the same way as sensors.

At least two markers are now respectively detected by the detection device. At this point, marker is the umbrella term for references markers or object markers, that is at least two reference markers, two object markers or one reference marker and object marker each are detected. These markers or the reference locations and sensors or objects represented by them are linked to one another, and indeed abstractly and/or geometrically. Abstractly means that only a simple relationship between the markers is provided that is called a proximity relationship. If two markers are neighbors in accordance with the relationship, they are, however not necessarily also neighbors in the sensor of critical geometry, for instance in the relationship “was measured with respect to”. The geometrical link preferably represents a spatial relationship in three dimensions, that is, for example, a transformation rule or a part from the one marker to the other marker. A link structure is thus produced with which the sensors and objects are localized with respect to the reference location.

The invention has the advantage that data and information on the sensors and objects can be visualized everywhere in the machine zone and also in its environment. The correct relationship is provided here; the data and information are reliably and easily recognizably associated with the sensors and the objects. A mobile end device without any special requirements such as a tablet or a smartphone is sufficient for the measurement and also for the later visualization. The putting into operation, servicing, and diagnosis of the machine zone or of the machines and sensors therein is thereby substantially simplified. Time and costs are saved and some errors are avoided.

The fitter is preferably automatically guided through the configuration by the detection device that respectively prompts to detect markers and automatically carries out their linking.

The detection of the markers preferably begins with a reference marker. All the abstract and geometrical links can then be linked at its reference location. A coordinate origin can naturally later be displaced with respect to this reference location. A coordinate system is preferably defined relative to the machine zone and not absolutely, in particular in the case of a moving machine zone such as with a vehicle All the sensors and other objects of interest are preferably provided with object markers and have reference markers attached so that at least one reference marker is easily visible from all relative observation locations or where they are possibly needed to bridge larger distances.

Markers are preferably detected and linked to one another pair-wise until the markers attached in the machine zone have been detected. This simplifies the handling and the insertion into the link structure. Long pairs of markers are thus detected until all the existing markers have been considered at least once. This is as a rule the responsibility of the fitter. If a marker is forgotten, the later visualization can have gaps and can then be corrected. In general, an automatic check whether all the markers have been detected would also be conceivable by recording an overview image of the machine zone and by counting the markers or by communication with the sensor network in the machine zone.

A check is preferably made whether one of the two markers respectively detected pair-wise had already been previously detected. The desired behavior of the fitter would be to respectively detect an already known marker and then a new marker. All the already detected markers are at least indirectly linked with one another in this manner and the link structure is successively expanded by a respective one marker. If both newly detected markers are still unknown, the processing can be rejected and the configuration can be continued after the detection of at least one other marker. Alternatively, a further link structure is produced from the two still unknown markers. If the same marker then later appears in a plurality of link structures, they can be connected to one another.

The detection device preferably prompts to first detect the one marker and then the other marker and subsequently shows the generated link between the two markers to have it acknowledged. The geometrical link and not the abstract link is preferably indicated, for example in an image of both markers with the calculated connection line therebetween. The fitter can recognize if the geometrical link is faulty. The calculation can then be repeated with another process or the fitter can be prompted to scan a different marker or to attach a new reference marker.

The abstract linking of the markers preferably takes place in the form of a graph. The nodes of the graph are the already detected and linked markers or the reference locations and objects or sensors represented by them. The edges are per se already the abstract proximity relationship; in addition to the edges, the geometrical transformation or a geometrical path from the one node or marker to the other node or marker can be stored.

The graph is preferably arranged or rearranged such that adjacent nodes in the graph are also geometrically adjacent. This can already be done on the pair-wise reading of markers or subsequent thereto. It is not ensured that the fitter respectively reads two markers adjacent in the geometrical sense. A discrepancy that thereby arises between the order in the graph and the geometrical order is resolved by a correction of the arrangement or rearrangement.

The geometrical link of the markers preferably takes place by evaluating a value and/or a format of the detected markers. This is a relatively simple method to determine geometrical relationships. With markers of a known shape and size, a conclusion can be drawn from the detected shape and size on the distance and the perspective of the detection and thus of the markers relative to the detection device. This is, however, only an example for a localization method, a large number of other localization methods are known, in particular a distance measurement by a 3D process or time of light measurement.

The geometrical linking of the markers preferably takes place in that the movement of the detection device between the detections of different markers is monitored, in that at least two markers are detected at the same time, or in that detections are evaluated during the alignment of the detection apparatus from the one marker to the other marker. If the fitter detects two markers after one another and these two markers are then localized relative to the detection device, an error can result due to interim movements and a rotation of the detection device on the conclusion of the relative arrangement of the two markers to one another. This can be eliminated by calculation in that the movement of the detection apparatus is detected, for example using an inertial measurement unit (IMU). A conclusion can also be drawn on the movement by intermediate detections during the alignment of the one marker with the other marker, for instance using a method of optical flow or in that intermediate images are joined to one another. The situation is comparatively simple when both markers are detected in the same image; the discussed error then does not arise. The fitter can also take care to move the detection device as little as possible between the two markers and to thereby keep said error small so that it does not have to be corrected.

A reference location is preferably associated with a detected reference marker and/or a detected object marker has the sensor represented by it associated with it. The reference location can be a geometrical position, for instance in the form of coordinates, but also only a point in the link structure, in particular a node in the graph. Instead of or in addition to the object marker, the sensor represented by it can be integrated abstractly and/or geometrically into the link structure. Additional configuration steps are also conceivable by the fitter here, for instance the input of a speaking name for the later visualization such as “laser scanner for protected field at material lock”.

An object marker is preferably arranged on a template with a mount for attachment to the sensor. Object markers are here not arranged as conventionally directly on the object or sensor, but rather at a preferably reusable template that is then attached to the sensor with the aid of the mount. This does not only provide a particularly simple possibility of reliably attaching object markers and removing them again. The template positions the object marker on the sensor in a defined manner, which facilitates the further processing.

Information on the position of the sensor relative to the object marker is preferably encoded in the object marker. Thanks to the template, the relative position of the object marker with respect to the actual sensor is fixed and known in advance, for example its optical center. The offset between the object marker and the actual sensor position can thus be reliably and simply corrected. The corresponding information can be encoded directly as a transformation or as relative coordinates or this is added subsequently from an identity of the object marker.

In a preferred further development, a method of visualizing a machine zone using a visualization device configured in accordance with the invention is provided in which a reference marker is first detected and visual sensor information from the environment of the reference marker is then presented. The user stands at a position in the machine zone or in its proximity and aligns the visualization device on a reference marker with reference to which the visualization device is oriented and determines which sensors are located in the environment. Virtual sensor information on these sensors is then presented at the correct location. The object markers have preferably been removed again at this point in time at which the configuration has ended, they are at least no longer needed.

Only sensor information from sensors that are neighbors of the detected reference marker in accordance with the abstract link is preferably presented. This is a possibility of selecting the presumably relevant and visible sensors from the current position of the visualization device. Direct neighbors are preferably selected, but 2-neighbors and the like as well as a restriction to a maximum distance are also conceivable.

The sensor information is preferably presented as a superposition with a live image. The virtual information is thus superposed on the real image and a particularly intuitive presentation is thus achieved (augmented reality).

The sensor information to be presented is preferably read by the sensor, by a controller connected to the sensor, and/or from a database for sensors. Some static information can already be detected via the object marker or a configuration input on its reading. The sensor itself or a higher ranking system to which the sensor is connected can deliver further information. A database with sensor data is conceivable as a further source.

The sensor information preferably comprises at least one of the following pieces of information: name of the sensor, address of the sensor, type of the sensor, a graphical model of the sensor, an alignment and/or a detection zone of the sensor, in particular a scanning plane, a field of view (FOV), a protected field or a region of interest, a sensor parameter such as its temperature or configuration, and/or measurement data of the sensor in any desired preparation as raw data, numerals images, point clouds, grid models of the objects detected by the sensor, and the like.

A template in accordance with the invention has an object marker for an embodiment of the configuration method in accordance with the invention, a mount suitable for a sensor, and a piece of information encoded in the object marker with which a location of the object marker is converted into a location of the sensor. The object can be attached to the sensor very easily in a defined manner via the template. It is no longer necessary to generate individual object markers per object. A template having an object marker suitable for the sensor type can rather be used multiple times.

The invention will be explained in more detail in the following also with respect to further features and advantages by way of example with reference to embodiments and to the enclosed drawing. The Figures of the drawing show in:

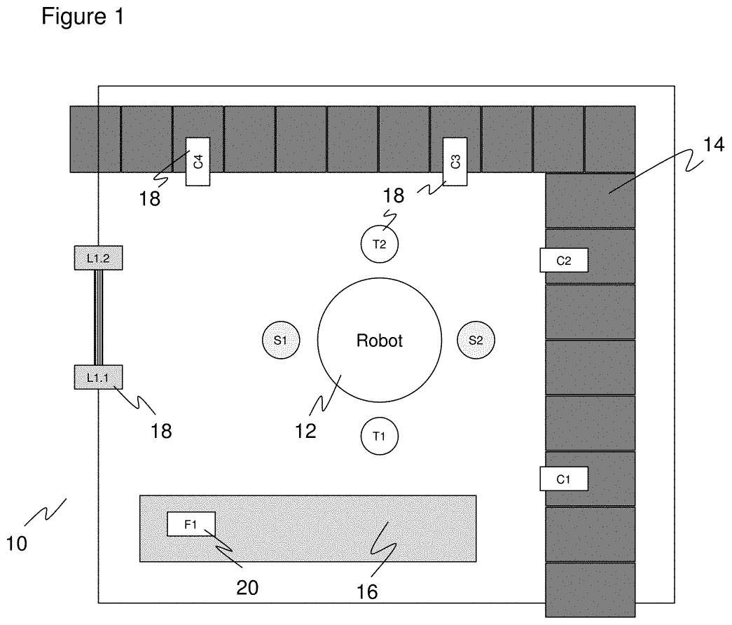

FIG. 1 an overview representation of a robot cell with an plurality of sensors;

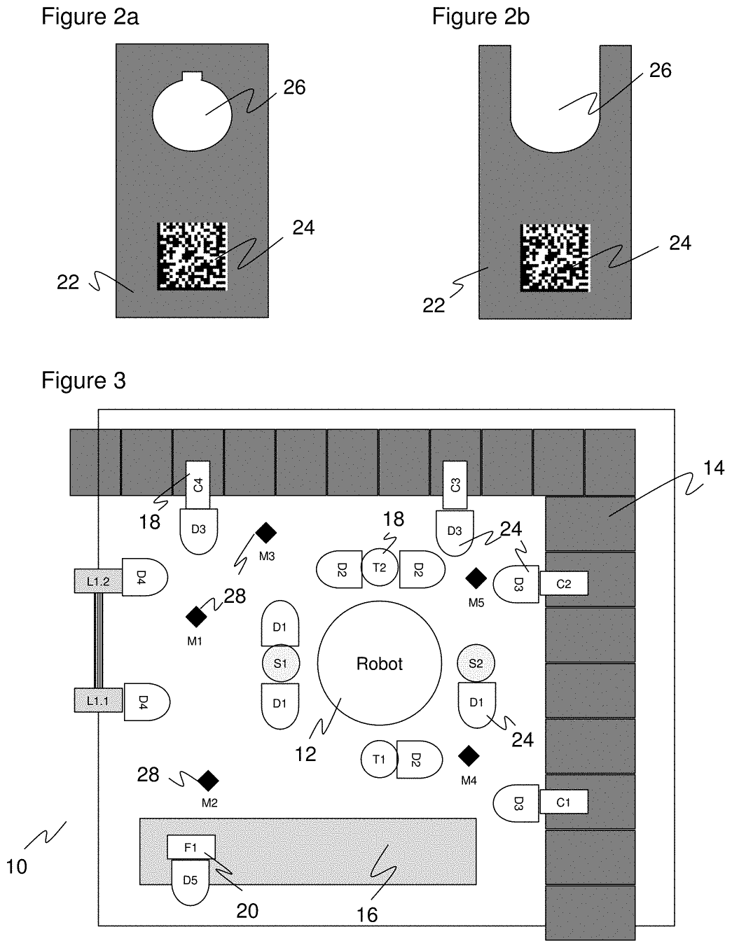

FIG. 2a a template with an object marker and a mount for attachment to a sensor;

FIG. 2b a template similar to FIG. 2a with a different object marker and a different mount for a different sensor type;

FIG. 3 an overview representation of the robot cell in accordance with FIG. 1 now with reference markers attached in the robot cell and object markers attached to the sensors;

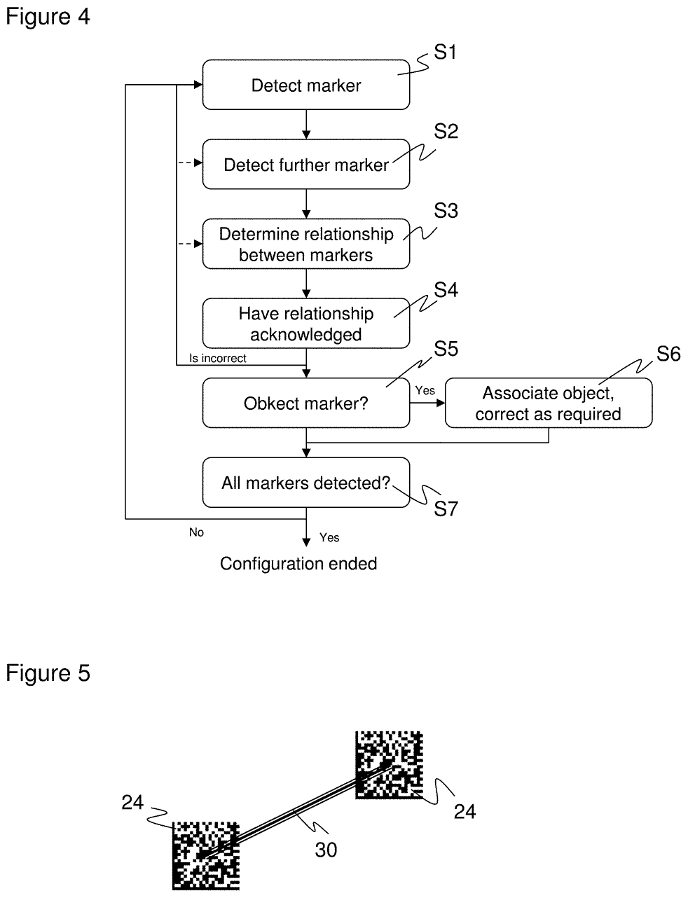

FIG. 4 an exemplary flowchart for the detection of the markers during a configuration of a visualization of the robot cell;

FIG. 5 an exemplary representation of the determined path between two detected markers for checking and confirming the path; and

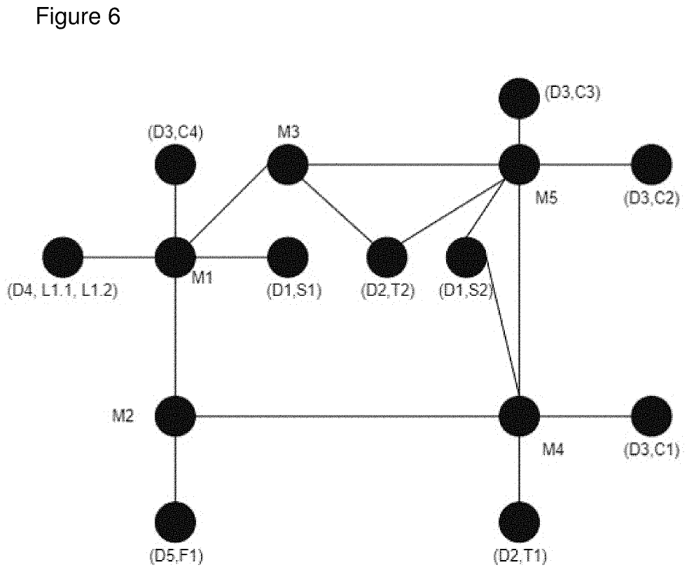

FIG. 6 an exemplary graph that is generated during a configuration from the successive detected markers in the robot cell in accordance with FIG. 3.

FIG. 1 shows an overview representation of a machine zone 10 that is here designed by way of example as a robot cell. Further elements, apart from a robot 12, for which a conveyor belt 14 and a switch cabinet 16 are shown as representative are located therein. A plurality of sensors 18 are mounted in the machine zone 10 to monitor the robot 12, the conveyor belt 14, and further elements of the machine zone 10, for example access paths or materials that are supplied to the robot 12 and are processed by it. The sensors 18 can work autonomously, but are as a rule connected to one another and/or to a higher ranking controller 20 marked as F1. The higher ranking controller 20 or cell controller is preferably likewise connected to the robot controller of the robot 12 or at least partly acts as this robot controller.

The following sensors 18 are installed in the machine zone 10 of FIG. 1: four laser scanners S1, S2, T1, and T2 around the robot 12, four cameras C1 to C4 at the conveyor belt 14, and a light grid L1.1-L1.2. that secures an access. The cameras C1 to C4 are of the same sensor type as one another. Of the laser scanners, two are safe laser scanners S1 and S2 for securing or for accident prevention and two are unsafe laser scanners T1 and T2 for general monitoring or automation work of the robot 12. The light grid with its safety function is likewise designed as safe. Safe sensors are shown by gray shading. The distinguishing into safe and unsafe sensors is as rule very significant in practice, but is here only one possibility for a distinguishing between sensor types. The selection and arrangement of the sensors 18 in FIG. 1 is to be understood purely by way of example overall.

The invention does not look into the design of a robot cell or more generally of a machine zone 10 and the selection and mounting of the required sensors 10. It should rather be of assistance in the configuration of the sensors 18, in particular as part of the putting into operation, diagnosis or servicing, and should provide a visualization of the machine zone 10 together with additional information on the sensors 18 or of the sensors 18 for this. This naturally does not preclude the fitter determining the need for additional sensor 18 or a different arrangement of the sensors 18 with reference to the visualization.

FIG. 2a shows a template 22 having an object marker 24 that is here designed as an optical 2D code. The object marker 24 can be read by image processing, for example by the camera of a smartphone. The specific design of the optical code and the reading process are not the subject matter of the invention; there are conventional solutions for this. It is in principle conceivable to use a non-optical object marker 24, for instance an RFID tag, but the localization works most reliably with optical codes and common end devices have cameras, but not necessarily an RFID reader.

A mount 26 is furthermore provided at the template 22 that is adapted to a specific sensor type. The template 22 can be attached to a sensor 18 of the matching sensor type in a well-defined and reliable manner with the aid of the mount 26, independently of the accessibility and size of the sensor 18. The object marker 24 is then located in a known relative position to the sensor 18 thanks to the template 22. The transformation from the location of the object marker 24 to the location of the sensor 18 is encoded in the object marker 24, either directly, for example in the form of relative coordinates, or indirectly in that a piece of identity information of the object marker 24 in a database or the like is linked to the associated relative coordinates. Thanks to the template 22 and the now known offset between the object marker 24 and the sensor 18 caused by the template 22, the sensor 18 is shown at the correct location and not at that of the object marker 24, for instance, later in the visualization. The template 22 is only required during the configuration of the visualization and can therefore be used multiple times.

FIG. 2b shows a template 22 having a different object marker 24 for a different sensor type. Apart from the code content of the object marker 24, the mount 26 is also varied so that the template 22 can be fastened to a sensor 18 of the different sensor type. A respective template 22 having a matching object marker 24 and a matching mount 26 is thus preferably generated and this only has to be done once per sensor type and not per individual sensor 18. Provided that a plurality of sensors 18 of the same sensor type are present in FIG. 1, a plurality of templates 22 are still required but are then preferably of the same type as one another. As an alternative to designing a separate template 22 for every sensor type, generic templates are also conceivable. Their mounts are as flexible as possible or they are attached with wire, adhesive, or the like. The generic template indicates the location, for instance with the aid of an arrow tip with respect to which the object marker 24 encodes the offset. On a careful attachment of the template, there is then likewise no offset between the object marker 24 and the sensor 18. The templates 22 can also be designed for different objects than sensors 18, for example machine parts, or a generic template 22 can be attached to another object. Such objects are thus included in the visualization.

FIG. 3 again shows the machine zone 10 of FIG. 1 once now object markers 24 have been attached to the sensors 18 and, as an example for a different object, also to the controller 20 and reference markers to a plurality of positions of the machine zone 10, for example on the hall floor.

One object marker 24 is attached per object to be localized, that is per sensor 18, but also per machine part, controller 20, or the like. This is preferably done via templates 22 and alternatively directly on the sensor 18 or another object. Object markers 24 are preferably not prepared individually for a sensor 18, but for a sensor type. In the example of FIG. 3, there are five different object markers 24 that are marked by D1 for safe laser scanners S1, S2, by D2 for unsafe laser scanners T1, T2, by D3 for (unsafe) cameras C1 to C4, by D4 for (safe) light grids L1.1-L1.2, and by D5 for the controller type of the controller 20 that acts as an example for a further object to be visualized that is not a sensor 18. Two respective objects markers 24 are shown at the sensors S1 and T2 that should not actually be attached in double form, but only illustrate that there are a plurality of possibilities or directions to fasten a template 22. This direction can reflect the direction of gaze of a sensor 18 or another object. With the light grid L1.1-L1.2 in contrast, both columns should actually be provided with a separate object marker 24 between which the monitoring beams run. As already mentioned in connection with FIGS. 2a-b, an object marker 24 preferably contains the information of which object or which sensor 18 it is, preferably at the level of types, variants, or families, and not individual objects or sensors, and a transformation from the location or origin of the object marker 24 to the location or origin of the object or sensor 18. The transformation enables a visualization at the desired or correct location and not at that of the object marker 24.

At least one reference marker 28 is attached in the machine zone 10 in addition to the object markers 24. The reference markers 28 can be positioned as desired by the fitter. They contain a unique code, for example a 32 digit identification number (universally unique identification, UUID) to preclude confusion with other markers in the machine zone 10. The reference markers 28 serve as reference points. It is later determined in the visualization with reference to a reference marker 28 read from the proximity where the origin of the visualization is and which sensors 18 are in the environment.

FIG. 4 shows an exemplary flowchart for a configuration of a visualization of the machine zone 10 on the basis of the object markers 24 and reference markers 28. This flow is based on a pair-wise reading of markers 24, 28. This is a simple procedure, but alternatively more than two markers 24, 28 can be read and put into relationship with one another per configuration step. The configuration takes place in a mobile end device that is called a detection device at some points, for example a smartphone or a tablet that automatically guides the fitter through the configuration.

In a step S1, a first marker 24, 28 is read, the fitter is therefore prompted to direct the detection device to a marker 24, 28 to be read and to trigger an image recording of a camera, for example. It is of advantage at the start of the configuration for a reference marker 28 to be read first. This then forms the reference point or point of origin. Alternatively, however, the anchoring can take place at a later point in time after a reference marker 28 has been detected.

In a step S2, a second marker 24, 28 is read. A pair of two markers has thus then been read, and indeed by choice of the fitter a pair of two object markers 24, of an object marker 24 and a reference marker 28, or of two reference markers 28 As already stated with respect to step S1, the fitter can be prompted at the first pair to choose at least one reference marker 28 so that there is a point of origin from the start. In later iterations, during the reading of further pairs, the detection device can require that a respective one of the read markers 24, 28 is already known to successively expand the link structure of the markers 24, 28 read during the configuration. Alternatively, two or even more initially separate link structures are generated that can then be joined together as soon as they overlap one another in at least one marker 24, 28 that has become known.

In a step S3, a relationship between the two read markers 24, 28 is automatically determined. There is already an abstract relationship in that the two markers 24, 28 are read together and are now automatically referenced to one another. A graph can, for example, be produced with this relationship that will be explained below with reference to FIG. 6. The geometrical relationship between the two read markers 24, 28 should, however, also further be determined, that is a transformation or a path from the one marker 24, 28 to the other marker 24, 28. Different image evaluation processes can be used for this that are known per se and that will not be further explained here. A conclusion can, for example, be drawn, only in outline, from the size of a marker 24, 28 or its perspective distortion on the mutual distance and position. That transformation can thus be found that transforms the one marker 24, 28 or its code elements or envelope into the other marker 24, 28. A special design of the markers 24, 28 can support such image processing.

In an optional step S4, the geometrical relationship is shown to have it acknowledged by the fitter. This is illustrated in FIG. 5 for two exemplary object markers 24. The calculated path 30 between the two object markers 24 is displayed so that the fitter can understand whether this path 30 actually transforms the two object markers 24 into one another. The geometrical relationship is stored after the acknowledgment by the fitter. If the fitter does not agree with the path 30, the detection device returns to one of the steps S1 to S3. An attempt is consequently made to recalculate the geometrical relationship with the read markers 24, 28 or at least one of the markers 24, 28 is read again, i.e. preferably at least one other marker 24, 28 is first integrated. Another remedying feature is the attachment of a further reference marker 28.

A check is made in a step S5 whether one of the read markers 24, 28 is an object marker 24. A sensor 18 or object is then associated with it in a step S6. In this process, user inputs can also optionally take place with which, for example, the sensor 18 or the object is provided with a name of its own. A reference location, for example a coordinate in a coordinate system, can be associated with reference markers 28. The first read reference marker 28 per link structure preferably fixes the coordinate system, with an origin being able to be displaced as desired. If a plurality of link structures are combined with one another once a marker 24, 28 has appeared in both, the coordinate systems are also aligned.

In a step S7, the configuration ends if all the markers 24, 28 have been detected once. Otherwise, at step S1, a new pair of markers 24, 28 is detected and processed in a further iteration. It is preferably part of the responsibility of the fitter to take all the markers 24, 28 into account. It is, however, also conceivable that the detection device has knowledge of the total number of markers 24, 28, for example via a specification, from an overview image of the machine zone 10 with all the markers 24, 28, or by communication with the sensors 18 or with the controller 20.

At the end of this configuration, the geometrical relationships between all the markers 24, 28 are known and thus all the sensors 18 and other objects such as the controller 20 with object markers 24 are localized. The object markers 24 or the templates 22 can now be removed.

FIG. 6 shows by way of example a graph produced after a completed configuration for the machine zone 10 shown in FIG. 3. The nodes correspond to the object markers 24 with the sensors 18 represented thereby and other objects such as the controller 20 and the reference markers 28. The edges correspond to the proximity relationships. If the fitter had selected a non-adjacent pair of markers 24, 28 in steps S1 and S2, the edges can be reordered using the geometrical relationships so that the proximity relationships in the graph agree with the actual geometry. The geometrical transformation is preferably also stored for the edges. It is thus, for example, therefore not only known that the reference marker M1 is the neighbor of the reference marker M3 in the graph, but also how M1 is geometrically transformed into M3 or where M3 is localized with respect to M1. Edges do not necessarily only represent relationships between a reference marker 28 and an object marker 24, but possibly also a relationship of one reference marker 28 to a further reference marker 28. This equally serves as a bridge to overcome distances that are too large without an optical link. Differing from the representation in FIG. 6, there can also be a plurality of graphs instead of only one single contiguous graph.

After a completed configuration, sensor data of the sensors 18 can now be visualized. A mobile end device that can, but does not have to, correspond to the detection device of the configuration, for example a smartphone, a tablet, or VR glasses, in turn serves as the visualization device. The user scans a reference marker 28 in his proximity. Sensors 18 and a possible further object such as the controller 20 are localized in the environment of the scanned reference marker 28 using the graph, in particular the direct or indirect neighbors of the scanned reference marker 28 in the graph. The required geometrical transformations are stored from the configuration in the edges of the graph. The sensor information or object information can thus be visualized at the correct location. This preferably has a camera image superposed (augmented reality).

A large variety of visualized information is conceivable. In addition to the name and type of a sensor 18, its configuration can be illustrated, for example a protected field of a laser scanner can be displayed, an operating parameter such as the temperature of the sensor 18 can be displayed, or measurement data of the sensor 18 are visualized. In the case of other objects such as the controller 20, the data are translated into a generic description and are provided with an associated visualization. It can be loaded in dependence on the kind of the visualization.

The invention has up to now been described for the example of a robot cell as the machine zone 10. The concept can be transferred to a vehicle, preferably an automated vehicle. Reference markers 28 and sensors 18 are located on the vehicle and thus in a fixed geometrical relationship to one another in the reference system of the vehicle so that the movement of the vehicle with respect to the external environment does not play a role and the configuration in accordance with the invention and the visualization remains comparable with a stationary machine zone 10. A machine zone 10 is, however, not restricted either to a robot cell or to a vehicle, but rather describes a zone in which at least one sensor 18 is located and in which interventions by a machine take place at least at times for which there are innumerable further examples such as a conveyor belt or also a railroad crossing.

In an expansion, a link to CAD information of the machine zone 10 can take place that as a rule anyway exists in the case of a robot cell or of a vehicle. Markers 24, 28 can thus be localized even more exactly or an optimum number and position of reference markers 28 can also be planned. 3D models can additionally be used to localize the sensors 18 themselves in addition to the markers 24, 28.

1. A method of configuring a visualization device for a machine zone in which at least one sensor is arranged,
wherein a reference marker is attached in the machine zone and an object marker is attached to the sensor; wherein a respective at least two markers are detected by a detection device; and wherein the two markers are linked to one another abstractly in their proximity relationship and/or geometrically in their mutual spatial locations.

2. The method in accordance with claim 1,
wherein markers are detected pair-wise and are linked with one another until the markers attached in the machine zone have been detected.

3. The method in accordance with claim 2,
wherein a check is made whether one of the two markers respectively detected pair-wise had already been previously detected.

4. The method in accordance with claim 2,
wherein the detection device prompts to detect first the one marker and then the other marker and subsequently shows the generated link between the two markers to have it acknowledged.

5. The method in accordance with claim 1,
wherein the abstract linking of the markers takes place in the form of a graph.

6. The method in accordance with claim 5,
wherein the graph is arranged or rearranged such that adjacent nodes in the graph are also geometrically adjacent.

7. The method in accordance with claim 1,
wherein the geometrical link of the markers takes place by evaluating a value and/or a format of the detected markers.

8. The method in accordance with claim 1,
wherein the geometrical link of the markers takes place in that the movement of the detection apparatus between the detections of different markers is monitored; and wherein at least two markers are detected at the same time.

9. The method in accordance with claim 1,
wherein the geometrical link of the markers takes place in that the movement of the detection apparatus between the detections of different markers is monitored; and detections are evaluated during the alignment of the detection apparatus from the one marker to the other marker.

10. The method in accordance with claim 1,
wherein a reference location is associated with a detected reference marker and/or a detected object marker has the sensor represented by it associated with it.

11. The method in accordance with claim 1,
wherein an object marker is arranged on a template with a mount for attachment to the sensor.

12. The method in accordance with claim 11,
wherein information on the position of the sensor relative to the object marker is encoded in the object marker.

13. A method of visualizing a machine zone using a visualization device for a machine zone in which at least one sensor is arranged, wherein a reference marker is attached in the machine zone and an object marker is attached to the sensor; wherein a respective at least two markers are detected by a detection device; and wherein the two markers are linked to one another abstractly in their proximity relationship and/or geometrically in their mutual spatial locations, in which method first the reference marker is detected and then virtual sensor information from the environment of the reference marker is presented.

14. The method in accordance with claim 13,
wherein only sensor information from sensors is presented that are neighbors of the detected reference marker in accordance with the abstract link.

15. The method in accordance with claim 13,
wherein the sensor information is shown as a superposition with a live image.

16. The method in accordance with claim 13,
wherein the sensor information to be presented is read by the sensor, by a controller connected to the sensor, and/or from a database for sensors.

17. The method in accordance with claim 13,
wherein the sensor information comprises at least one of the following pieces of information: name of the sensor, address of the sensor, type of the sensor, a graphical model of the sensor, an alignment and/or a detection zone of the sensor, a sensor parameter, and/or measurement data of the sensor.

18. The method in accordance with claim 17,
wherein the detection zone of the sensor is a protected field or a region of interest.

19. A template having an object marker for a configuration method of configuring a visualization device for a machine zone in which at least one sensor is arranged, wherein a reference marker is attached in the machine zone and an object marker is attached to the sensor; wherein a respective at least two markers are detected by a detection device; and wherein the two markers are linked to one another abstractly in their proximity relationship and/or geometrically in their mutual spatial locations, wherein the template has, in addition to the object marker, a mount suitable for a sensor and information encoded in the object marker with which a location of the object marker can be converted into a location of the sensor.
